(19) United States
(12) Patent Application Publication
(10) Pub. No.: US 2025/0067261 A1
(43) Pub. Date: Feb. 27, 2025

(54) MOTOR-DRIVEN COMPRESSOR

(71) Applicant: KABUSHIKI KAISHA TOYOTA JIDOSHOKKI, Aichi-ken (JP)

(72) Inventors: Keisuke ISOBE, Kariya-shi (JP); Shuji TAKIMOTO, Kariya-shi (JP); Tomoaki MIYATA, Kariya-shi (JP)

(73) Assignee: KABUSHIKI KAISHA TOYOTA JIDOSHOKKI, Aichi-ken (JP)

(21) Appl. No.: 18/802,441

(22) Filed: Aug. 13, 2024

(30) Foreign Application Priority Data
Aug. 22, 2023 (JP) 2023-134737

(51) Int. Cl. F04C 18/02; H02K 3/28; H02K 3/32; H02K 3/34

(52) U.S. Cl. CPC F04C 18/0215; H02K 3/28; H02K 3/325; H02K 3/345; F04C 2240/40

(57) ABSTRACT

A motor-driven compressor includes a compression unit, a motor including a stator, and a housing. The stator includes a stator core, coils of multiple phases, an insulator, a phase-to-phase insulation sheet, and a cover member. The cover member includes an annular cover end wall and a tubular cover inner wall that extends toward the insulator inner wall from a radially inner portion of the cover end wall. The cover end wall includes a conical tapered wall that is inclined such that the distance between the cover end wall and the insulator inner wall decreases as the cover end wall extends toward the cover inner wall. The tapered wall is continuous with the cover inner wall.

### CROSS-REFERENCE TO RELATED APPLICATIONS

This application is based upon and claims the benefit of priority from prior Japanese Patent Application No. 2023-134737, filed on Aug. 22, 2023, the entire contents of which are incorporated herein by reference.

### BACKGROUND

### 1. Field

The present disclosure relates to a motor-driven compressor.

### 2. Description of Related Art

A motor-driven compressor includes a rotary shaft, a compression unit, a motor, and a housing. The compression unit compresses a fluid by rotation of the rotary shaft. The motor rotates the rotary shaft. The housing includes a motor chamber. The motor chamber accommodates the motor. The motor includes a stator.

For example, Japanese Laid-Open Patent Publication No. 2022-150980 discloses a stator that includes a stator core, coils of multiple phases, and insulators. The stator core is fixed to the housing. The coils of the respective phases are formed by windings of multiple phases that are wound on the stator core in a concentrated manner. The coils of the respective phases include coil ends. The coil ends protrude from core end faces of the stator core in the axial direction of the rotary shaft. The insulators are disposed to face the core end face of the stator core. The insulators insulate the coils and the core end face from each other. The insulators each include an insulator inner wall. Each insulator inner wall is disposed at a position that is inward of and overlaps with one of the coil ends in the radial direction of the rotary shaft.

The stator includes phase-to-phase insulation sheets. Each phase-to-phase insulation sheet extends in the radial direction of the rotary shaft. Each phase-to-phase insulation sheet insulates coils that are adjacent to each other in the circumferential direction of the rotary shaft from each other. The phase-to-phase insulation sheets protrude from the core end faces of the stator core. Each phase-to-phase insulation sheet insulates coil ends that are adjacent to each other in the circumferential direction of the rotary shaft in a state in which a part of the phase-to-phase insulation sheet protrudes beyond the coil ends on the side opposite to the core end face. Since the phase-to-phase insulation sheets partially protrude beyond the coil ends on the side opposite to the core end face, insulation between the coil ends adjacent to each other in the circumferential direction of the rotary shaft is easily ensured.

This type of stator is coupled to the housing by fitting the stator core to the inner circumferential surface of the housing through, for example, shrink-fitting. In the shrink-fitting, the housing is thermally expanded so that the inner diameter of the housing becomes larger than the outer diameter of the stator core. Subsequently, the stator core is inserted into the housing to reach a predetermined shrink-fitting position. Then, as the temperature of the housing becomes closer to normal temperature, the housing shrinks. This brings the inner circumferential surface of the housing into close contact with the outer circumferential surface of the stator core.

Thus, when the stator core is shrink-fitted to the housing, the stator core is positioned by, for example, inserting a jig into the stator core. The housing is disposed in relation to the stator core such that the stator core, of which the position relative to the jig is determined, is inserted into the inner circumferential surface of the housing to the predetermined shrink-fitting position. In this manner, the stator is coupled to the housing.

When inserting the jig into the stator core, the jig may contact the coil ends or a part of the phase-to-phase insulation sheet that extends beyond the coil ends and the insulator inner walls on the side opposite to the core end face. This may damage the coils or deform the phase-to-phase insulation sheets, and thus hinders reliable insulation between coil ends adjacent to each other in the circumferential direction of the rotary shaft. This lowers the reliability of the motor.

The stator may include a cover member having an insulating property. The cover member is disposed to face the insulators. Such a cover member may include, for example, an annular cover end wall and a tubular cover inner wall. The cover end wall covers the coil ends on the side opposite to the core end face with respect to the coil ends in the axial direction of the rotary shaft. Furthermore, the cover end wall covers a part of each phase-to-phase insulation sheet that protrudes beyond the coil ends and the insulator inner wall on the side opposite to the core end face. The cover inner wall extends toward the insulator inner walls from a radially inner portion of the cover end wall.

With this configuration, when a jig for shrink-fitting the stator core to the housing is inserted into the stator core, the cover end wall and the cover inner wall prevent the jig from contacting the coil ends. Also, the cover end wall and the cover inner wall prevent the jig from contacting a part of the phase-to-phase insulation sheet that protrudes beyond the coil ends and the insulator inner wall on the side opposite to the core end face. As a result, the coils are prevented from being damaged, and the phase-to-phase insulation sheets are prevented from being deformed. Accordingly, the insulation between the coil ends adjacent to each other in the circumferential direction of the rotary shaft is not hindered. The reliability of the motor is thus improved.

However, if the cover end wall of the cover member is disposed to cover the coil ends or parts of the phase-to-phase insulation sheets that protrude beyond the coil ends or the insulator inner wall on the side opposite to the core end face, the jig interferes with the cover member when being inserted into the stator core. This may hinder smooth insertion of the jig into the stator core. This reduces the assembling efficiency of the stator to the housing.

Therefore, it is desirable to facilitate the insertion of the jig into the stator core while avoiding contact between the jig and the coil ends and between the jig and the parts of the phase-to-phase insulation sheets that protrude beyond the coil ends or the insulator inner wall on the side opposite to the core end face. That is, it is desired that the assembling efficiency of the stator to the housing be facilitated while improving the reliability of the motor.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a motor-driven compressor includes a rotary shaft, a compression unit configured to compress a fluid by rotation of the rotary shaft, a motor configured to rotate the rotary shaft, and a housing that includes a motor chamber accommodating the motor. The motor includes a stator. The stator includes a stator core fixed in the housing, coils, an insulator, phase-to-phase insulation sheets, and a cover member. The coils of multiple phases are formed by windings of multiple phases wound on the stator core in a concentrated manner. The coils have coil ends protruding from a core end face of the stator core in an axial direction of the rotary shaft. The insulator is disposed to face the core end face. The insulator insulates the coils and the core end face from each other. Each of the phase-to-phase insulation sheets extends in a radial direction of the rotary shaft and insulates the coils that are adjacent to each other in a circumferential direction of the rotary shaft from each other. The cover member has an insulating property and is disposed to face the insulator. The insulator includes an insulator inner wall that is disposed at a position overlapping with the coil ends on an inner side of the coil ends in the radial direction of the rotary shaft. Each phase-to-phase insulation sheet insulates the coil ends that are adjacent to each other in the circumferential direction in a state in which the phase-to-phase insulation sheet protrudes beyond the core end face and partially protrudes beyond the insulator inner wall on a side opposite to the core end face. The cover member includes an annular cover end wall and a tubular cover inner wall. The annular cover end wall covers the coil ends on a side opposite to the core end face in the axial direction, and covers a part of each phase-to-phase insulation sheet that protrudes beyond the insulator inner wall on the side opposite to the core end face. The tubular cover inner wall extends toward the insulator inner wall from a radially inner portion of the cover end wall. The cover end wall includes a conical tapered wall that is inclined such that the distance between the cover end wall and the insulator inner wall decreases as the cover end wall extends toward the cover inner wall. The tapered wall is continuous with the cover inner wall.

Other features and aspects will be apparent from the following detailed description, the drawings, and the claims.

### BRIEF DESCRIPTION OF THE DRAWINGS

FIG. 1 is a cross-sectional view showing a motor-driven compressor according to an embodiment.

FIG. 2 is a cross-sectional view of a motor.

FIG. 3 is an exploded perspective view of a stator core, a first insulator, and a second insulator.

FIG. 4 is a perspective view of a stator, illustrating a state before a cover member is disposed on the first insulator.

FIG. 5 is a perspective view of a stator, illustrating a state in which the cover member is disposed on the first insulator.

FIG. 6 is a cross-sectional view showing part of the stator.

FIG. 7 is a perspective view for explaining a phase-to-phase insulation sheet.

FIG. 8 is a cross-sectional view showing part of the stator.

FIG. 9 is a cross-sectional view showing part of the stator.

FIG. 10 is a cross-sectional view showing part of the motor-driven compressor.

FIG. 11 is a cross-sectional view illustrating a shrink-fitting process.

FIG. 12 is a cross-sectional view illustrating the shrink-fitting process.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

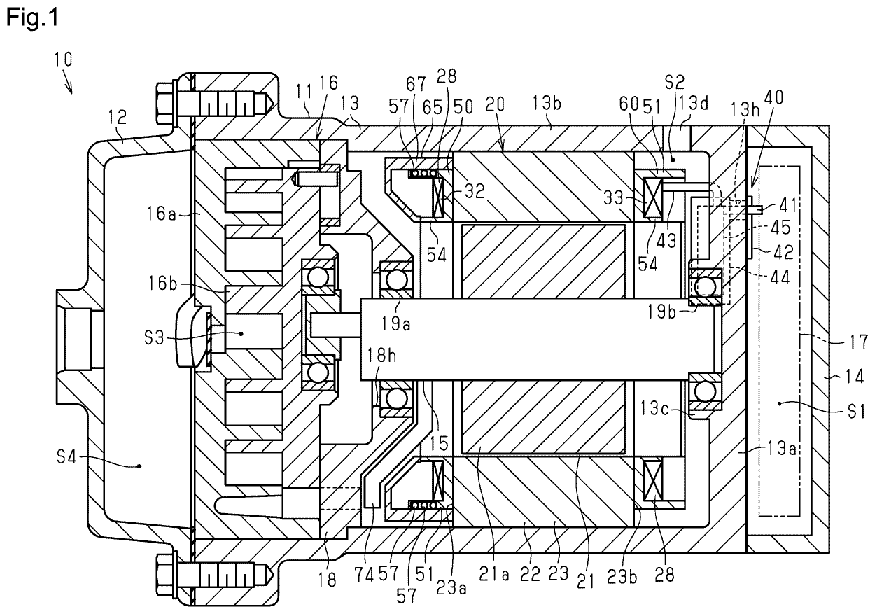

A motor-driven compressor 10 according to an embodiment will now be described with reference to FIGS. 1 to 12. The motor-driven compressor 10 of the present embodiment is used, for example, in a vehicle air conditioner.

### Basic Configuration of Motor-Driven Compressor

As shown in FIG. 1, the motor-driven compressor 10 includes a tubular housing 11. The housing 11 includes a discharge housing member 12, a motor housing member 13, and an inverter case 14. The discharge housing member 12, the motor housing member 13, and the inverter case 14 are made of metal. The discharge housing member 12, the motor housing member 13, and the inverter case 14 are made of, for example, aluminum.

The motor housing member 13 includes an end wall 13a and a peripheral wall 13b. The end wall 13a is plate-shaped. The peripheral wall 13b tubularly extends from the outer periphery of the end wall 13a. The discharge housing member 12 is tubular. The discharge housing member 12 is coupled to an end of the peripheral wall 13b of the motor housing member 13 on a side opposite to the end wall 13a. The inverter case 14 is tubular. The inverter case 14 is coupled to the end wall 13a of the motor housing member 13. The end wall 13a of the motor housing member 13 and the inverter case 14 define an inverter chamber S1.

The motor housing member 13 includes a boss 13c. The boss 13c is cylindrical. The boss 13c protrudes from a center portion of the end wall 13a of the motor housing member 13. The boss 13c extends from a surface of the end wall 13a that defines a motor chamber S2. The axis of the boss 13c agrees with the axis of the peripheral wall 13b of the motor housing member 13. The end wall 13a of the motor housing member 13 includes a hole 13h. The hole 13h extends through the end wall 13a of the motor housing member 13 in the thickness direction. The hole 13h is located closer to the peripheral wall 13b than the boss 13c is.

The motor housing member 13 includes a suction port 13d. The suction port 13d is provided in a section of the peripheral wall 13b of the motor housing member 13 that is close to the end wall 13a. The suction port 13d connects the interior and the exterior of the motor housing member 13 to each other. Refrigerant, which is fluid, is drawn into the suction port 13d from the outside.

The motor-driven compressor 10 includes a rotary shaft 15, a compression unit 16, an inverter 17, and a motor 20. The rotary shaft 15, the compression unit 16, and the motor 20 are accommodated in the motor housing member 13. Thus, the housing 11 accommodates the motor 20. The rotary shaft 15 is disposed in the motor housing member 13 with the axis of the rotary shaft 15 agreeing with the axis of the peripheral wall 13b of the motor housing member 13. The inverter 17 is accommodated in the inverter chamber S1.

The compression unit 16 and the motor 20 are located next to each other in an axial direction in which the axis of the rotary shaft 15 extends. The motor 20 is disposed to be closer to the end wall 13a of the motor housing member 13 than the compression unit 16 is. The compression unit 16, the motor 20, and the inverter 17 are disposed in that order in the axial direction of the rotary shaft 15.

The motor-driven compressor 10 includes a shaft supporting member 18. The shaft supporting member 18 is disposed between the compression unit 16 and the motor 20. The shaft supporting member 18 thus serves as a partition wall between the motor 20 and the compression unit 16. The end wall 13a and the peripheral wall 13b of the motor housing member 13 and the shaft supporting member 18 define the motor chamber S2. The housing 11 thus includes the motor chamber S2. The motor chamber S2 accommodates the motor 20. Refrigerant is drawn into the motor chamber S2 through the suction port 13d.

The shaft supporting member 18 includes an insertion hole 18h. The insertion hole 18h is located at the center of the shaft supporting member 18. The axis of the insertion hole 18h agrees with the axis of the boss 13c. A first end of the rotary shaft 15 is inserted through the insertion hole 18h. A radial bearing 19a is provided between the insertion hole 18h and the first end of the rotary shaft 15. The first end of the rotary shaft 15 is rotationally supported by the shaft supporting member 18 with the radial bearing 19a. A second end of the rotary shaft 15 is inserted into the boss 13c. A radial bearing 19b is provided between the boss 13c and the second end of the rotary shaft 15. The second end of the rotary shaft 15 is rotationally supported by the boss 13c with the radial bearing 19b.

The compression unit 16 includes a fixed scroll 16a and an orbiting scroll 16b. The fixed scroll 16a is fixed to the motor housing member 13. The fixed scroll 16a is thus fixed to the housing 11. The orbiting scroll 16b is disposed to be opposed to the fixed scroll 16a. The orbiting scroll 16b meshes with the fixed scroll 16a and orbits as the rotary shaft 15 rotates. The compression unit 16 is driven by rotation of the rotary shaft 15. The compression unit 16 compresses refrigerant. Compression chambers S3, the volume of which is variable, are defined between the fixed scroll 16a and the orbiting scroll 16b. A discharge chamber S4 is defined between the fixed scroll 16a and the discharge housing member 12. Changes in the volumes of the compression chambers S3 compress the refrigerant, which is then discharged to the discharge chamber S4. The motor 20 rotates the rotary shaft 15. The compression unit 16 is driven by rotation of the rotary shaft 15. The compression unit 16 compresses refrigerant by rotation of the rotary shaft 15.

### Schematic Configuration of Motor

The motor 20 includes a rotor 21 and a stator 22. The stator 22 is tubular. The rotor 21 is disposed on the inner side of the stator 22. The rotor 21 includes a cylindrical rotor core 21a and permanent magnets (not shown) embedded in the rotor core 21a. The rotor core 21a is fixed to the rotary shaft 15. The rotor core 21a is configured to rotate integrally with the rotary shaft 15.

### Stator Core

The stator 22 includes a stator core 23. The stator core 23 is fixed to the inner circumferential surface of the peripheral wall 13b of the motor housing member 13. The stator core 23 is thus fixed to the housing 11. The stator 22 is coupled to the housing 11 by fitting the stator core 23 to the inner circumferential surface of the peripheral wall 13b of the motor housing member 13 through, for example, shrink-fitting. The axis of the stator core 23 agrees with the axis of the rotary shaft 15. Thus, the axial direction of the stator core 23 agrees with the axial direction of the rotary shaft 15.

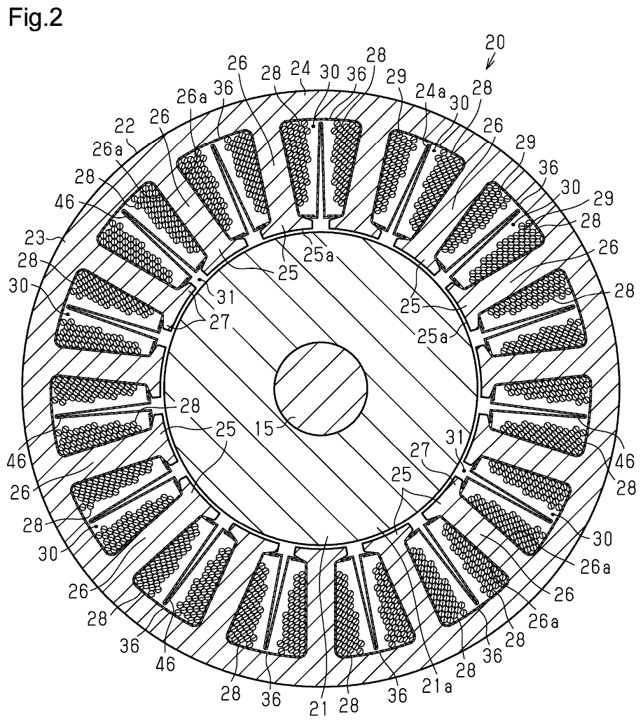

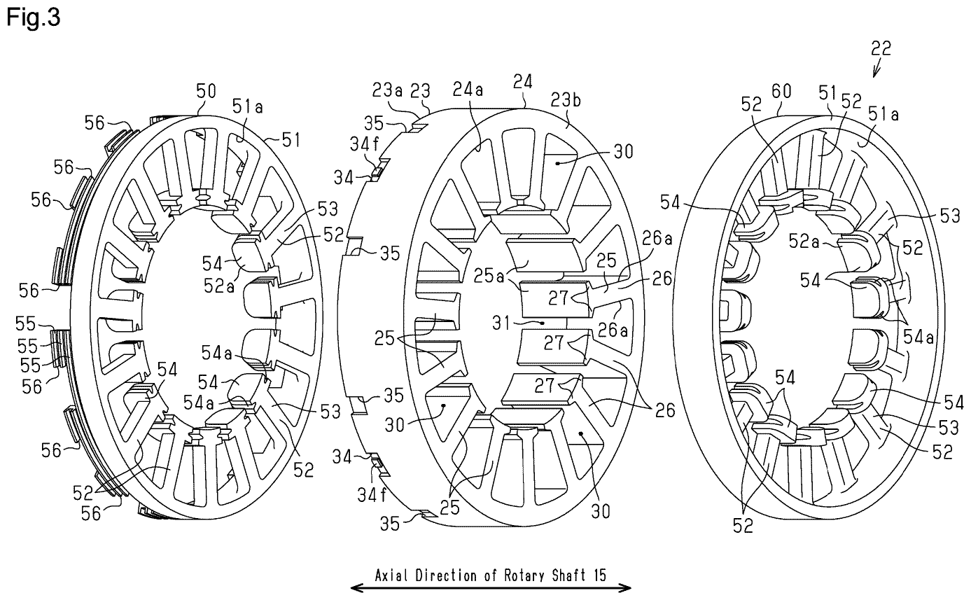

As shown in FIGS. 2 and 3, the stator core 23 includes a yoke 24 and teeth 25. The yoke 24 is cylindrical. The stator core 23 is fixed to the motor housing member 13 by fitting the outer circumferential surface of the yoke 24 into the inner circumferential surface of the peripheral wall 13b of the motor housing member 13. The axial direction of the yoke 24 is also referred to as the axial direction of the stator core 23. Therefore, the axial direction of the yoke 24 is also referred to as the axial direction of the rotary shaft 15.

The teeth 25 extend inward from an inner circumferential surface 24a of the yoke 24 in a radial direction of the yoke 24. The radial direction of the yoke 24 is also referred to as the radial direction of the rotary shaft 15. The teeth 25 are spaced apart from each other in the circumferential direction of the yoke 24. The teeth 25 are disposed at equal intervals in the circumferential direction of the yoke 24. The circumferential direction of the yoke 24 is also referred to as the circumferential direction of the stator core 23. The circumferential direction of the yoke 24 is also referred to as the circumferential direction of the rotary shaft 15. Each tooth 25 extends from the inner circumferential surface 24a of the yoke 24 toward the axis of the stator core 23. In the present embodiment, the stator core 23 includes fifteen teeth 25. Although the number of the teeth 25 is not particularly limited, the number of the teeth 25 is a multiple of three.

As shown in FIG. 3, opposite end faces of the yoke 24 in the axial direction are flat. Opposite end faces of each tooth 25 in the axial direction of the yoke 24 are flat. The length of the yoke 24 in the axial direction is equal to the length of each tooth 25 in the axial direction of the yoke 24. One side in the axial direction of the yoke 24, that is, a first end face located on a first side, is located on the same plane as one side of each tooth 25 in the axial direction of the yoke 24, that is, a first end face on the first side of each tooth 25. The other side in the axial direction of the yoke 24, that is, a second end face located on a second side, is located on the same plane as the other side of each tooth 25 in the axial direction of the yoke 24, that is, a second end face on the second side of each tooth 25.

The first end face of the yoke 24 on the first side in the axial direction and the first end faces of the teeth 25 on the first side in the axial direction of the yoke 24 form a first core end face 23a located on the first side in the axial direction of the stator core 23. The second end face of the yoke 24 on the second side in the axial direction and the second end faces of the teeth 25 on the second side in the axial direction of the yoke 24 form a second core end face 23b located on the second side in the axial direction of the stator core 23. The stator core 23 thus includes the first core end face 23a and the second core end face 23b. The first core end face 23a is a core end face located on the first side in the axial direction of the rotary shaft 15 in the stator core 23. The second core end face 23b is a core end face located on the second side in the axial direction of the rotary shaft 15 in the stator core 23.

As shown in FIG. 1, the stator core 23 is disposed in the motor housing member 13 such that the first core end face 23a faces the shaft supporting member 18 in the axial direction of the rotary shaft 15, and that the second core end face 23b faces the end wall 13a of the motor housing member 13 in the axial direction of the rotary shaft 15.

As shown in FIGS. 2 and 3, each tooth 25 includes a tooth extension 26 and a tooth flange 27. The tooth extension 26 is a thin plate that extends from the inner circumferential surface 24a of the yoke 24. The tooth extension 26 extends from the first core end face 23a to the second core end face 23b of the stator core 23. The tooth extension 26 includes tooth side surfaces 26a located on opposite sides of the tooth extension 26 in the circumferential direction of the yoke 24. The tooth side surfaces 26a are continuous with the inner circumferential surface 24a of the yoke 24. The tooth flange 27 projects in the circumferential direction of the yoke 24 from the ends of the tooth side surfaces 26a on the side opposite to the yoke 24. The tooth flange 27 thus projects from the end of the tooth extension 26 on the side opposite to the yoke 24 toward the opposite sides in the circumferential direction of the yoke 24.

The stator core 23 includes slots 30. Each slot 30 is formed between two of the teeth 25 that are adjacent to each other in the circumferential direction of the yoke 24. Each slot 30 is a space defined by an inner circumferential surface 24a of the yoke 24, tooth side surfaces 26a adjacent to each other in the circumferential direction of the yoke 24, and surfaces of the tooth flanges 27 that faces the yoke 24. Further, the stator core 23 includes slot openings 31. Each slot opening 31 is a gap between two of the tooth flanges 27 that are adjacent to each other in the circumferential direction of the yoke 24. Each slot opening 31 is connected to the corresponding slot 30.

As shown in FIGS. 3, 4, and 5, the yoke 24 includes first insertion recesses 34. Each first insertion recess 34 is formed in the outer circumferential surface of the yoke 24. Each first insertion recess 34 opens in the first core end face 23a of the stator core 23. The first insertion recesses 34 are disposed in the outer circumferential surface of the yoke 24 at equal intervals in the circumferential direction of the yoke 24. The yoke 24 includes, for example, four first insertion recesses 34. Each first insertion recess 34 includes a locking projection 34f. The locking projection 34f protrudes from the first insertion recess 34 in the radial direction of the yoke 24.

The yoke 24 includes second insertion recesses 35. Each second insertion recess 35 is formed in the outer circumferential surface of the yoke 24. Each second insertion recess 35 opens in the first core end face 23a of the stator core 23. The second insertion recesses 35 are disposed in the outer circumferential surface of the yoke 24 at equal intervals in the circumferential direction of the yoke 24.

### Insulators

As shown in FIG. 3, the stator 22 includes a first insulator 50. The first insulator 50 is tubular. The stator 22 also includes a second insulator 60. The second insulator 60 is tubular. The first insulator 50 and the second insulator 60 are made of, for example, plastic.

The first insulator 50 and the second insulator 60 each include an insulator base 51 and insulator tooth portions 52. The insulator base 51 is cylindrical. The first insulator 50 and the second insulator 60 are disposed on the stator core 23 with the axes of the insulator bases 51 agreeing with the axis of the yoke 24. The axial direction of each insulator base 51 is also referred to as the axial direction of the yoke 24. The circumferential direction of each insulator base 51 is also referred to as the circumferential direction of the yoke 24. Further, the radial direction of each insulator base 51 is also referred to as the radial direction of the yoke 24.

The first insulator 50 is disposed to face the first core end face 23a of the stator core 23 while being in contact with the first core end face 23a. The second insulator 60 is disposed to face the second core end face 23b of the stator core 23 while being in contact with the second core end face 23b. The outer diameter of each insulator base 51 is smaller than the outer diameter of the yoke 24. The inner diameter of each insulator base 51 is equal to the inner diameter of the yoke 24.

The insulator tooth portions 52 extend inward in the radial direction of the insulator base 51 from an inner circumferential surface 51a of the insulator base 51. The insulator tooth portions 52 are spaced apart from each other in the circumferential direction of the insulator base 51. The insulator tooth portions 52 are disposed at equal intervals in the circumferential direction of the insulator base 51. Each insulator tooth portion 52 extends from the inner circumferential surface 51a of the insulator base 51 toward the axis of the insulator base 51. In the present embodiment, each of the first insulator 50 and the second insulator 60 includes fifteen insulator tooth portions 52. The number of the insulator tooth portions 52 is the same as the number of the teeth 25 of the stator core 23.

Each insulator tooth portion 52 includes an insulator extension 53. The first insulator 50 and the second insulator 60 thus include multiple insulator extensions 53. Each insulator extension 53 has the shape of a post that extends inward in the radial direction of the insulator base 51 from the inner circumferential surface 51a of the insulator base 51. The width of each insulator extension 53 in the circumferential direction of the insulator base 51 is equal to the width of each tooth extension 26 in the circumferential direction of the yoke 24. Each insulator extension 53 is in contact with the corresponding tooth 25. Thus, each insulator extension 53 is located at a position that overlaps with the corresponding tooth extension 26 in the axial direction of the yoke 24.

Each insulator tooth portion 52 includes an insulator inner wall 54. Each of the first insulator 50 and the second insulator 60 thus includes the insulator inner walls 54. Each insulator inner wall 54 protrudes along the insulator base 51 from an end of the insulator extension 53 on the side opposite to the insulator base 51. Each insulator inner wall 54 protrudes from the corresponding insulator extension 53 toward the opposite sides in the circumferential direction of the insulator base 51 and toward the side opposite to the stator core 23 in the axial direction of the insulator base 51. In this manner, each insulator inner wall 54 protrudes from the corresponding insulator extension 53. Each insulator inner wall 54 is located at a position overlapping with the corresponding tooth flange 27 in the axial direction of the yoke 24.

Each insulator tooth portion 52 includes a surface 52a on a side opposite to the insulator base 51. The surface 52a is located on the same plane as a surface 25a of the corresponding tooth 25 on the side opposite to the yoke 24. Each insulator inner wall 54 has a surface on the side opposite to the insulator base 51 that forms the surface 52a of the insulator tooth portion 52 on the side opposite to the insulator base 51. A surface of each tooth flange 27 located on the side opposite to the yoke 24 forms a surface 25a of the corresponding tooth 25 located on the side opposite to the yoke 24. The thickness of each insulator inner wall 54 is greater than the thickness of each tooth flange 27. Thus, parts of each tooth flange 27 on the surfaces facing the yoke 24 are blocked in the corresponding slots 30 by the corresponding insulator inner walls 54 in the axial direction of the yoke 24.

Each insulator inner wall 54 includes insertion grooves 54a. Each insertion groove 54a is formed in one of the surfaces of the corresponding insulator inner wall 54 on the opposite sides in the circumferential direction of the insulator base 51. The insertion grooves 54a extend through the insulator inner wall 54 in the axial direction of the insulator base 51. The space inside each insertion groove 54a is a part of the space between two of the insulator inner walls 54 that are adjacent to each other in the circumferential direction of the yoke 24.

The first insulator 50 includes three guide grooves 55. The three guide grooves 55 are arranged in the axial direction of the first insulator 50. The three guide grooves 55 are formed in the outer circumferential surface of the insulator base 51. The three guide grooves 55 extend in the circumferential direction of the first insulator 50. The first insulator 50 includes five through-grooves 56, each corresponding to one of the guide grooves 55. Each through-groove 56 extends through the insulator base 51 in the radial direction.

### Coils

As shown in FIG. 2, the stator 22 includes coils 28 of multiple phases. The stator 22 includes coils 28 that respectively correspond to a U-phase, a V-phase, and a W-phase. The coils 28 are formed by windings 29 of respective phases wound on the stator core 23 in a concentrated manner. Therefore, the stator 22 includes the coils 28 of multiple phases, which are formed by the windings 29 of multiple phases wound on the stator core 23 in a concentrated manner. The coil 28 of each phase has parts that pass through the corresponding slots 30.

As shown in FIG. 1, the stator 22 includes first coil ends 32 and second coil ends 33. The first coil ends 32 are each part of the coil 28 of the corresponding phase and protrudes from the first core end face 23a. The second coil ends 33 are each part of the coil 28 of the corresponding phase and protrudes from the second core end face 23b. Thus, the first coil ends 32 and the second coil ends 33 are parts of the coils 28 of the respective phases and protrude from the core end faces. In this manner, each coil 28 includes coil ends that are formed by windings 29 wound on the stator core 23. The coil ends protrude from the core end faces of the stator core 23 that are end faces in the axial direction of the rotary shaft 15.

The coils 28 of the respective phases are each formed using a series winding configuration. In a series winding configuration, first, the windings 29 of each phase passing through the corresponding slots 30 are wound around the corresponding tooth extensions 26, the corresponding insulator extensions 53 of the first insulator 50, and the corresponding insulator extensions 53 of the second insulator 60. The winding 29 of each phase is sequentially wound, using a concentrated winding configuration, around every third set of the tooth extension 26, the insulator extension 53 of the first insulator 50, and the insulator extension 53 of the second insulator 60 in the circumferential direction of the stator core 23. Thus, the coils 28 of each phase are disposed with two sets of the extensions 26, 53 in between in the circumferential direction of the stator core 23. In the present embodiment, five coils 28 are provided for each phase. The coils 28 of the respective phases are disposed in the slots 30 such that coils 28 of different phases are adjacent to each other in the circumferential direction of the rotary shaft 15. In this manner, the coils 28 are formed by the windings 29, which pass through the slots 30 and are wound around the respective sets of the tooth extensions 26, the insulator extensions 53 of the first insulator 50, and the insulator extensions 53 of the second insulator 60.

The first insulator 50 insulates the coils 28 of the respective phases from the first core end face 23a. The insulator base 51 of the first insulator 50 is disposed at a position overlapping with the first coil ends 32 on the outer side of the first coil ends 32 in the radial direction of the rotary shaft 15. Each insulator inner wall 54 of the first insulator 50 is disposed at a position overlapping with the corresponding first coil end 32 on the inner side of the first coil end 32 in the radial direction of the rotary shaft 15. Thus, each insulator inner wall 54 of the first insulator 50 is located at a position that overlaps with the corresponding tooth flanges 27 in the axial direction of the rotary shaft 15 and also overlaps with the corresponding first coil end 32 in the radial direction of the rotary shaft 15.

The second insulator 60 insulates the coils 28 of the respective phases from the second core end face 23b. The insulator base 51 of the second insulator 60 is disposed at a position overlapping with the second coil ends 33 on the outer side of the second coil ends 33 in the radial direction of the rotary shaft 15. Each insulator inner wall 54 of the second insulator 60 is disposed at a position overlapping with the corresponding second coil end 33 on the inner side of the second coil end 33 in the radial direction of the rotary shaft 15. Thus, each insulator inner wall 54 of the second insulator 60 is located at a position that overlaps with the corresponding tooth flanges 27 in the axial direction of the rotary shaft 15 and also overlaps with the corresponding second coil end 33 in the radial direction of the rotary shaft 15.

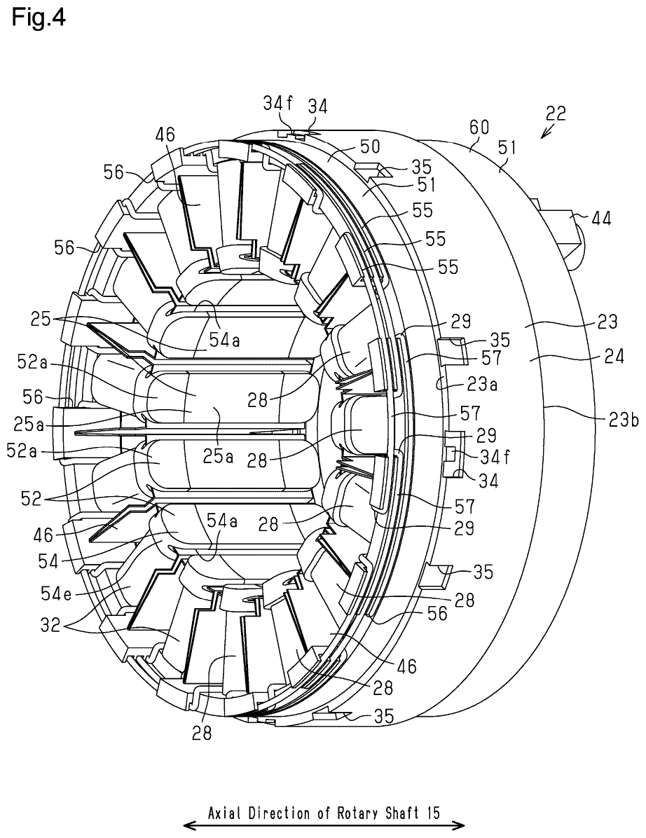

As shown in FIG. 4, the windings 29 of each phase include connection wires 57 that connect the coils 28 of the same phase in the circumferential direction of the stator core 23. The connection wires 57 of each phase are routed out from the first coil ends 32 of the coils 28 of the corresponding phase and are guided by the corresponding through-grooves 56 to the corresponding guide grooves 55.

### Slot Insulating Portions

As shown in FIG. 2, the stator 22 includes slot insulating portions 36. One slot insulating portion 36 is disposed in each slot 30. Each slot insulating portion 36 has the form of a sheet. Each slot insulating portion 36 is formed by bending a belt-shaped insulating sheet along the inner circumferential surface 24a of the yoke 24 and the corresponding tooth side surfaces 26a that are adjacent to each other in the circumferential direction of the yoke 24. The slot insulating portion 36 is inserted into the slot 30 with the longitudinal direction of the slot insulating portion 36 agreeing with the axial direction of the yoke 24. The slot insulating portion 36 extends from the first core end face 23a to the second core end face 23b of the stator core 23. The slot insulating portion 36 further protrudes in the axial direction of the rotary shaft 15 from both of the first core end face 23a and the second core end face 23b. The slot insulating portions 36 insulate the stator core 23 from parts of the coils 28 passing through the slots 30.

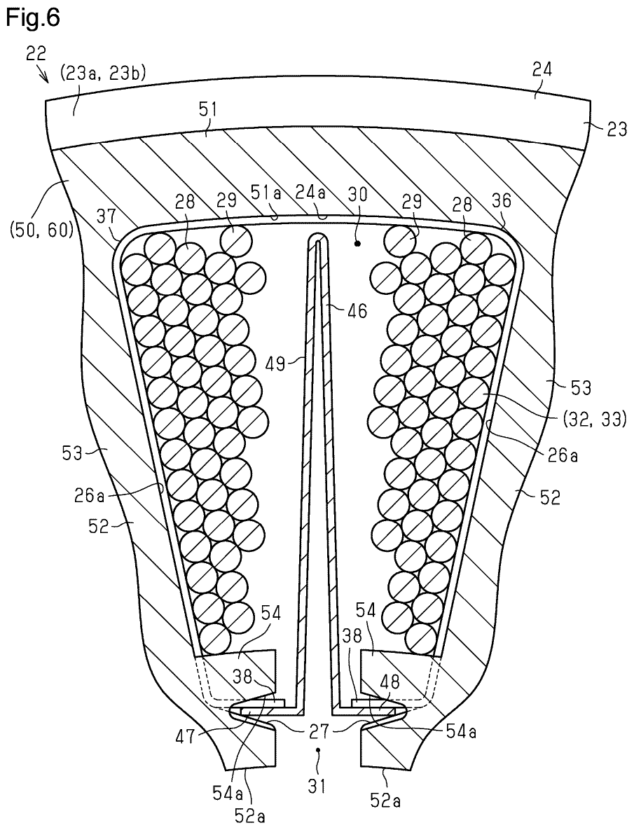

As shown in FIG. 6, each slot insulating portion 36 includes an insulation main body 37. The insulation main body 37 is a portion of the slot insulating portion 36 extending along the inner circumferential surface 24a of the yoke 24 and the tooth side surfaces 26a that are adjacent to each other in the circumferential direction of the yoke 24. Therefore, the slot insulating portion 36 extends along the inner circumferential surface 24a of the yoke 24 and the tooth side surfaces 26a that are adjacent to each other in the circumferential direction of the yoke 24.

Each slot insulating portion 36 includes two overhangs 38. The overhangs 38 extend toward each other from the two ends of the insulation main body 37 located on the side opposite to the inner circumferential surface 24a of the yoke 24. Thus, the two overhangs 38 respectively project toward each other from the tooth side surfaces 26a that are adjacent to each other in the circumferential direction of the yoke 24. The two overhangs 38 insulate the corresponding tooth flanges 27 located on the opposite sides of the slot opening 31 and the corresponding coils 28 from each other. Each overhang 38 is spaced apart from the corresponding tooth flange 27.

### Phase-To-Phase Insulation Sheet

As shown in FIG. 2, the stator 22 includes phase-to-phase insulation sheets 46. One phase-to-phase insulation sheet 46 is disposed in each slot 30. Each phase-to-phase insulation sheet 46 has the form of a sheet. Each phase-to-phase insulation sheet 46 is formed by bending a belt-shaped insulating sheet. The phase-to-phase insulation sheet 46 is inserted in the slot 30 with the longitudinal direction of the phase-to-phase insulation sheet 46 agreeing with the axial direction of the yoke 24. Thus, the longitudinal direction of the phase-to-phase insulation sheet 46 agrees with the axial direction of the rotary shaft 15.

As shown in FIG. 6, each phase-to-phase insulation sheet 46 includes a first insulating portion 47, a second insulating portion 48, and a third insulating portion 49. The first insulating portion 47 is disposed between one of the two tooth flanges 27 located on the opposite sides of the slot opening 31 and the corresponding one of the two overhangs 38 located on the opposite sides of the slot opening 31. That is, the first insulating portion 47 is disposed between the tooth flange 27 on the left side in FIG. 6 and the overhang 38 on the left side in FIG. 6. The first insulating portion 47 and the corresponding overhang 38 overlap with each other in the radial direction of the yoke 24. The first insulating portion 47 insulates the corresponding tooth flange 27 from one of the two coils 28 that are adjacent to each other in the circumferential direction of the yoke 24 in the corresponding slot 30.

The second insulating portion 48 is disposed between the other one of the two tooth flanges 27 located on the opposite sides of the slot opening 31 and the corresponding one of the two overhangs 38 located on the opposite sides of the slot opening 31. That is, the second insulating portion 48 is disposed between the tooth flange 27 on the right side in FIG. 6 and the overhang 38 on the right side in FIG. 6. The second insulating portion 48 and the corresponding overhang 38 overlap with each other in the radial direction of the yoke 24. Thus, the overhangs 38 and the phase-to-phase insulation sheet 46 overlap with each other in the radial direction of the yoke 24. The second insulating portion 48 insulates the corresponding tooth flange 27 from the other one of the two coils 28 that are adjacent to each other in the circumferential direction of the yoke 24 in the corresponding slot 30.

The third insulating portion 49 has a V-shaped cross-sectional shape that extends from the end of the first insulating portion 47 closer to the second insulating portion 48 toward the inner circumferential surface 24a of the yoke 24, is then bent and extends toward the second insulating portion 48 to be connected to the end of the second insulating portion 48 closer to the first insulating portion 47. The third insulating portion 49 thus connects the first insulating portion 47 and the second insulating portion 48 to each other. In this manner, the phase-to-phase insulation sheet 46 extends in the radial direction of the rotary shaft 15. The third insulating portion 49 is disposed in each slot 30 between the coils 28 that are adjacent to each other in the circumferential direction of the rotary shaft 15. The third insulating portion 49 insulates the coils 28 that are adjacent to each other in the circumferential direction of the rotary shaft 15 in the slot 30 from each other. Thus, the third insulating portion 49 has a V-shaped cross-sectional shape that connects the first insulating portion 47 and the second insulating portion 48 to each other and insulates the coils 28 that are adjacent to each other in the circumferential direction of the rotary shaft 15 in the slot 30.

In this manner, the phase-to-phase insulation sheet 46 is disposed to extend over the slot opening 31 in the circumferential direction of the rotary shaft 15. The phase-to-phase insulation sheet 46 insulates the tooth flanges 27 and the coils 28 on the opposite sides of the slot opening 31 from each other. The phase-to-phase insulation sheet 46 extends in the radial direction of the rotary shaft 15 and insulates the coils 28 that are adjacent to each other in the circumferential direction of the rotary shaft 15.

As shown in FIG. 4, the opposite ends in the longitudinal direction of each phase-to-phase insulation sheet 46 respectively protrude from the first core end face 23a and the second core end face 23b. As shown in FIG. 6, parts of the first insulating portion 47 and the second insulating portion 48 of each phase-to-phase insulation sheet 46 that protrude from the first core end face 23a and the second core end face 23b are inserted into the space between two of the insulator inner walls 54 that are adjacent to each other in the circumferential direction of the rotary shaft 15. The first insulating portion 47 is inserted into one of the insertion grooves 54a that form part of the space between two of the insulator inner walls 54 that are adjacent to each other in the circumferential direction of the yoke 24. The second insulating portion 48 is inserted into the other one of the insertion grooves 54a that form part of the space between the two of the insulator inner walls 54 that are adjacent to each other in the circumferential direction of the yoke 24. In this manner, the phase-to-phase insulation sheet 46 protrudes from each of the first core end face 23a and the second core end face 23b into the space between two of the insulator inner walls 54 that are adjacent to each other in the circumferential direction of the rotary shaft 15.

As shown in FIG. 4, each phase-to-phase insulation sheet 46 partially protrudes beyond the insulator inner walls 54 of the first insulator 50 on the side opposite to the first core end face 23a, and insulates the corresponding first coil ends 32, adjacent to each other in the circumferential direction of the rotary shaft 15, from each other. Although not illustrated, each phase-to-phase insulation sheet 46 partially protrudes beyond the insulator inner walls 54 of the second insulator 60 on the side opposite to the second core end face 23b, and insulates the corresponding second coil ends 33, adjacent to each other in the circumferential direction of the rotary shaft 15, from each other.

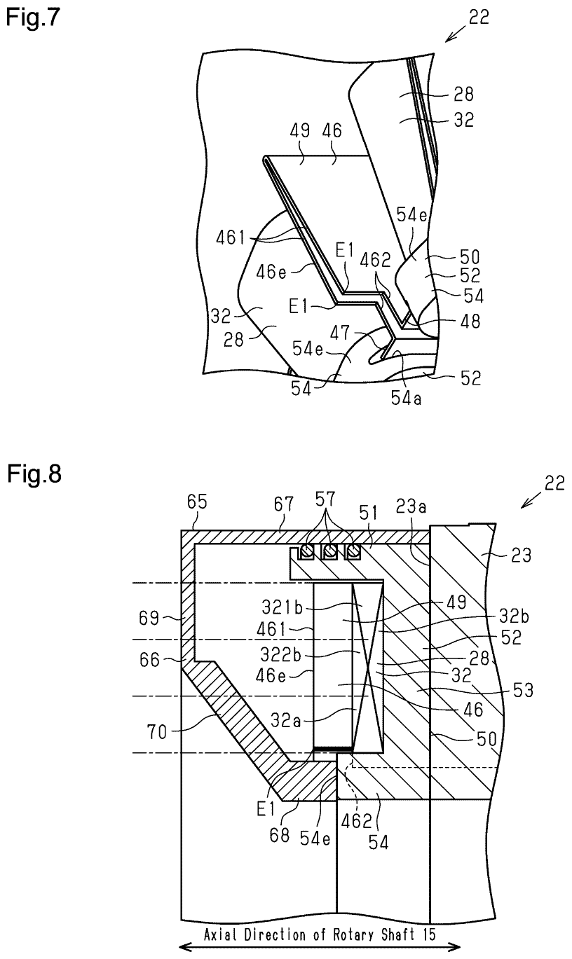

As shown in FIG. 7, an edge 46e of each phase-to-phase insulation sheet 46 in the axial direction of the rotary shaft 15 includes first edges 461 and second edges 462. The first edges 461 are parts of the edge 46e of the phase-to-phase insulation sheet 46 and protrude beyond the first coil ends 32 on the side opposite to the first core end face 23a. The first edges 461 protrude beyond the first coil ends 32 on the side opposite to the first core end face 23a. On the opposite to the first core end face 23a, the first edges 461 protrude beyond the inner wall ends 54e of the insulator inner walls 54 on the side opposite to the first core end face 23a. The first edges 461 are formed by the edges of the third insulating portion 49 in the axial direction of the rotary shaft 15.

The second edges 462 are parts of the edge 46e of the phase-to-phase insulation sheet 46 that do not protrude from the inner wall end 54e of the insulator inner wall 54. In other words, the second edges 462 are parts of the edge 46e of the phase-to-phase insulation sheet 46 that have a shorter length than the inner wall ends 54e of the insulator inner walls 54. Therefore, the second edges 462 do not protrude beyond the inner wall ends 54e of the insulator inner walls 54 on the side opposite to the first core end face 23a. The second edges 462 are located closer to the first core end face 23a than the insulator inner walls 54 are. The second edges 462 do not protrude beyond the first coil ends 32 on the side opposite to the first core end face 23a. The second edges 462 are formed by parts of the edge of the third insulating portion 49 that are located on the inner side of the parts forming the first edges 461 in the radial direction of the rotary shaft 15 and the edges of the first insulating portion 47 and the second insulating portion 48 in the axial direction of the rotary shaft 15. The second edges 462 are provided to extend from ends μl of the first edges 461 that are located on the inner side in the radial direction of the rotary shaft 15 to edges of the phase-to-phase insulation sheet 46 that are located on the inner side in the radial direction of the rotary shaft 15.

### Cover Member

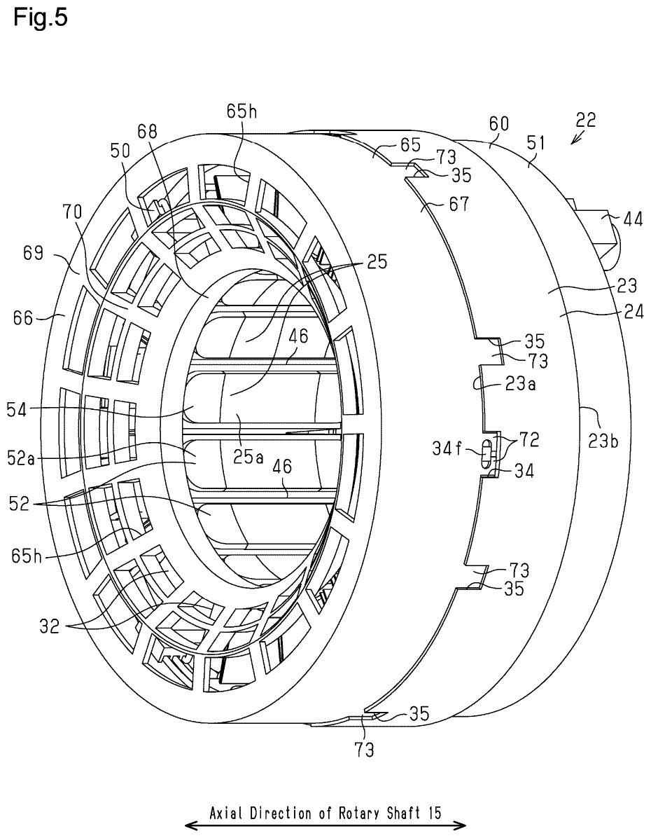

As shown in FIG. 5, the stator 22 includes a cover member 65. The cover member 65 is cylindrical. The cover member 65 has an insulating property. The cover member 65 is made of, for example, plastic. The cover member 65 is disposed to face the first insulator 50.

The cover member 65 includes a cover end wall 66, a cover outer wall 67, and a cover inner wall 68. The cover end wall 66 is annular. The cover end wall 66 includes multiple through-holes 65h.

The cover end wall 66 includes a flat wall 69 and a tapered wall 70. The flat wall 69 is annular. The flat wall 69 has the shape of a flat plate. The flat wall 69 extends in the radial direction of the rotary shaft 15. The tapered wall 70 is conical and extends from the radially inner portion of the flat wall 69 toward the radially inner side of the cover end wall 66 while being inclined. A radially inner portion of the tapered wall 70 forms a radially inner portion of the cover end wall 66. The radially outer portion of the flat wall 69 forms the radially outer portion of the cover end wall 66.

As shown in FIG. 8, the cover end wall 66 faces the first coil end 32 in the axial direction of the rotary shaft 15. The cover end wall 66 covers the first coil ends 32 on the side opposite to the first core end face 23a in the axial direction of the rotary shaft 15, and covers portions of the phase-to-phase insulation sheets 46 that protrude beyond the insulator inner wall 54 on the side opposite to the first core end face 23a.

The cover outer wall 67 extends cylindrically in the axial direction of the rotary shaft 15 from the radially outer portion of the flat wall 69. The cover outer wall 67 thus extends cylindrically from the radially outer portion of the cover end wall 66. The inner diameter of the cover outer wall 67 is larger than the outer diameter of the insulator base 51. The cover outer wall 67 surrounds the insulator base 51 of the first insulator 50.

The cover inner wall 68 extends in the axial direction of the rotary shaft 15 from the radially inner portion of the tapered wall 70. The cover inner wall 68 thus extends cylindrically from the radially inner portion of the cover end wall 66. The cover inner wall 68 faces the insulator inner walls 54 of the first insulator 50 in the axial direction of the rotary shaft 15. Therefore, the cover inner wall 68 extends from the radially inner portion of the cover end wall 66 toward the insulator inner wall 54 and overlaps with the insulator inner wall 54 in the axial direction of the rotary shaft 15. The tapered wall 70 is inclined such that the distance between the tapered wall 70 and the insulator inner wall 54 decreases as the tapered wall 70 extends toward the cover inner wall 68. The tapered wall 70 is continuous with the cover inner wall 68.

A case will now be described in which each first coil end 32 is divided into three equal parts along the length in the radial direction of the rotary shaft 15. Each first coil end 32 includes a radially inner portion 32a and a radially outer portion 32b. The radially inner portion 32a is a part located at the innermost position in the radial direction of the rotary shaft 15 when the first coil end 32 is divided into three equal parts along the length in the radial direction of the rotary shaft 15. The radially outer portion 32b is a part of the first coil end 32 that is located on an outer side of the radially inner portion 32a in the radial direction of the rotary shaft 15.

The tapered wall 70 is inclined from a part of the cover end wall 66 that overlaps with the radially outer portion 32b of each first coil end 32 in the axial direction of the rotary shaft 15. Specifically, the radially outer portion 32b includes a first radially outer portion 321b and a second radially outer portion 322b. The first radially outer portion 321b is a part of the radially outer portion 32b located at the outermost position in the radial direction of the rotary shaft 15 when the first coil end 32 is divided into three equal parts along the length in the radial direction of the rotary shaft 15. The second radially outer portion 322b is a part of the radially outer portion 32b that is located inward of the first radially outer portion 321b in the radial direction of the rotary shaft 15. The tapered wall 70 is inclined from a part of the cover end wall 66 that overlaps with the second radially outer portion 322b of the first coil end 32 in the axial direction of the rotary shaft 15.

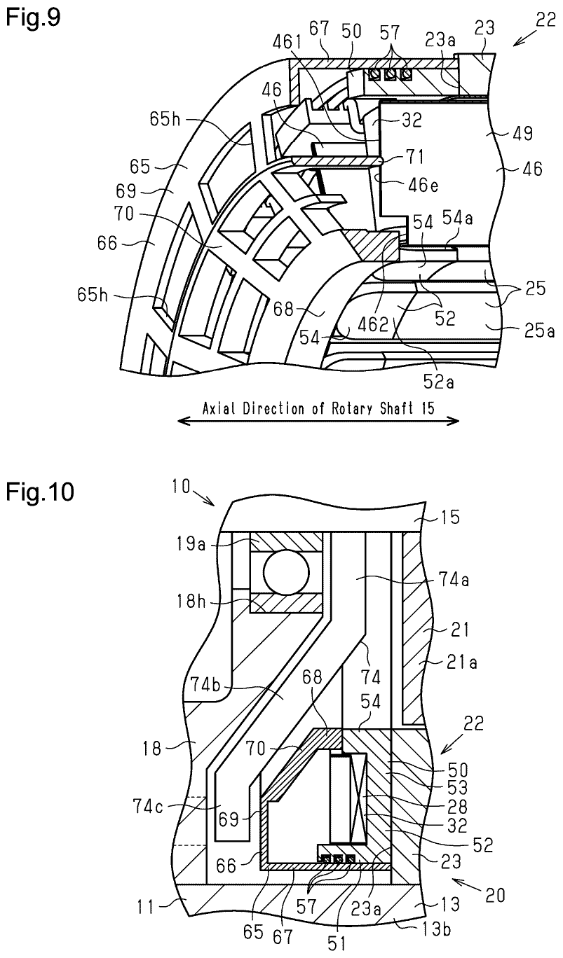

As shown in FIG. 9, the cover end wall 66 is provided with a restricting portion 71, that is, a stopper. The restricting portion 71 protrudes from an inner surface of the cover end wall 66 that faces the first coil ends 32. The restricting portion 71 is annular and extends in the circumferential direction of the cover end wall 66. The restricting portion 71 has the shape of a thin plate. The restricting portion 71 protrudes toward the first coil ends 32 from the boundary between the flat wall 69 and the tapered wall 70 of the cover end wall 66.

The restricting portion 71 is configured such that the distal end of the restricting portion 71 contacts the edge 46e of each phase-to-phase insulation sheet 46. The distal end of the restricting portion 71 is allowed to contact the center in the radial direction of the rotary shaft 15 of the first edge 461 of each phase-to-phase insulation sheet 46. In this manner, the restricting portion 71 contacts the edges 46e of the phase-to-phase insulation sheets 46 in the axial direction of the rotary shaft 15. The restricting portion 71 contacts the edges 46e in the axial direction of the rotary shaft 15 of the phase-to-phase insulation sheets 46, thereby restricting movement of the phase-to-phase insulation sheets 46 in the axial direction of the rotary shaft 15.

As shown in FIG. 1, the cover outer wall 67 of the cover member 65 is located between the connection wires 57 of the respective phases and the peripheral wall 13b of the motor housing member 13. The cover outer wall 67 of the cover member 65 ensures insulation between the connection wires 57 of the different phases and the motor housing member 13.

As shown in FIG. 5, the cover member 65 includes multiple pairs of locking tabs 72. Each pair of the locking tabs 72 extend in the axial direction of the yoke 24 from the edge of the cover outer wall 67 of the cover member 65 on the side opposite to the cover end wall 66. The pairs of locking tabs 72 are disposed at equal intervals in the circumferential direction of the cover outer wall 67 of the cover member 65. The cover member 65 includes, for example, four pairs of the locking tabs 72.

Each locking tab 72 has the shape of an elongated flat plate. The longitudinal direction of the locking tab 72 agrees with the axial direction of the yoke 24. The locking tabs 72 extend parallel with each other. The distal ends of the locking tabs 72 are hook-shaped and face each other.

Each first insertion recess 34 receives a pair of the locking tabs 72. Each first insertion recess 34 receives a pair of the locking tabs 72 such that the locking projection 34f is located between the two locking tabs 72. Accordingly, the locking tabs 72 is engaged with the locking projection 34f. In this manner, the cover member 65 is attached to the stator core 23. When the locking tabs 72 are engaged with the locking projections 34f, the locking tabs 72 are prevented from coming off the first insertion recesses 34. In this manner, the engagement of the locking projection 34f with the locking tabs 72 restricts movement of the cover member 65 relative to the first insulator 50 in the axial direction of the yoke 24.

The cover member 65 includes multiple insertion tabs 73. Each insertion tab 73 extends in the axial direction of the yoke 24 from the edge of the cover outer wall 67 of the cover member 65 on the side opposite to the cover end wall 66. The insertion tabs 73 are disposed at equal intervals in the circumferential direction of the cover inner wall 68. Each insertion tab 73 has the shape of an elongated plate. Each insertion tab 73 has a longitudinal direction that agrees with the longitudinal direction of the yoke 24.

Each insertion tab 73 is inserted into the corresponding second insertion recess 35. Each insertion tab 73 is allowed to contact the side surfaces of the corresponding second insertion recess 35 in a state in which the insertion tab 73 is inserted into the second insertion recess 35. When the cover member 65 vibrates, each insertion tab 73 is slidable with respect to the side surfaces of the corresponding second insertion recess 35. The sliding motion of each insertion tab 73 on the side surfaces of the corresponding second insertion recess 35 suppresses friction between each pair of the locking tabs 72 and the side surfaces of the corresponding first insertion recess 34.

As shown in FIG. 10, the rotary shaft 15 includes a balancer 74. The balancer 74 has the shape of a plate. The balancer 74 protrudes outward in the radial direction of the rotary shaft 15 from a part of the outer circumferential surface of the rotary shaft 15 that is located at an inner side of the cover inner wall 68. The balancer 74 cancels the centrifugal force acting on the orbiting scroll 16b due to rotation of the rotary shaft 15. The rotary shaft 15 is thus provided with the balancer 74 configured to cancel the centrifugal force acting on the orbiting scroll 16b due to rotation of the rotary shaft 15.

The balancer 74 includes a first extension 74a, a second extension 74b, and a third extension 74c. The first extension 74a extends in the radial direction of the rotary shaft 15 from the outer circumferential surface of the rotary shaft 15. The second extension 74b extends obliquely with respect to the extending direction of the first extension 74a from an end of the first extension 74a on the side opposite to the outer circumferential surface of the rotary shaft 15. The second extension 74b extends obliquely with respect to the axial direction of the rotary shaft 15. The second extension 74b extends from the first extension 74a in a direction away from the stator core 23. The third extension 74c extends outward in the radial direction of the rotary shaft 15 from an end of the second extension 74b on a side opposite to the first extension 74a. The second extension 74b of the balancer 74 extends along the tapered wall 70. Therefore, the balancer 74 extends along the tapered wall 70 while protruding outward in the radial direction of the rotary shaft 15 from the part of the outer circumferential surface of the rotary shaft 15 that is located on the inner side of the cover inner wall 68.

### Hermetic Terminal

As shown in FIG. 1, the motor-driven compressor 10 includes a hermetic terminal 40. The hermetic terminal 40 includes three conductive members 41, which respectively correspond to the coils 28 of the respective phases. The motor-driven compressor 10 thus includes the conductive members 41. FIG. 1 shows only one conductive member 41. Each conductive member 41 is a columnar metal terminal that extends linearly. Each conductive member 41 includes a first end that is electrically connected to the inverter 17 in the inverter chamber S1. Each conductive member 41 includes a second end that projects from the inverter chamber S1 into the motor housing member 13 through the hole 13h. The hermetic terminal 40 includes a support plate 42. The support plate 42 supports the three conductive members 41 while insulating the three conductive members 41 from each other. The support plate 42 is fixed to the outer surface of the end wall 13a of the motor housing member 13 around the hole 13h in the inverter chamber S1.

The stator 22 includes lead wires 43. The lead wires 43 are routed out of the motor 20. The lead wires 43 are routed out from the second coil ends 33 of the coils 28 of the respective phases. Thus, three lead wires 43 are routed out from the motor 20. FIG. 1 shows only one of the lead wires 43.

The stator 22 includes a cluster block 44. The cluster block 44 accommodates three connection terminals 45, which correspond to the coils 28 of the respective phases. The cluster block 44 has an insulating property. The cluster block 44 is made of, for example, plastic. Each connection terminal 45 electrically connects the corresponding conductive member 41 to the corresponding lead wire 43.

The power from the inverter 17 is supplied to the motor 20 via the conductive members 41, the connection terminals 45, and the lead wires 43. This drives the motor 20. The inverter 17 thus drives the motor 20.

### Operation of Embodiment

Operation of the present embodiment will now be described.

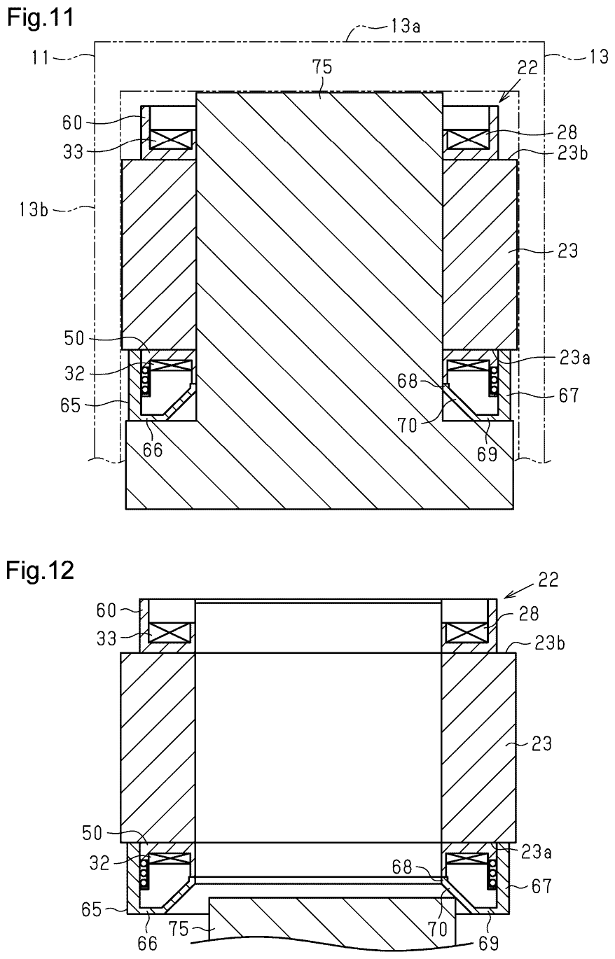

As shown in FIG. 11, the stator 22 is coupled to the housing 11 by fitting the stator core 23 to the inner circumferential surface of the peripheral wall 13b of the motor housing member 13 through, for example, shrink-fitting. In the shrink-fitting, the motor housing member 13 is thermally expanded so that the inner diameter of the peripheral wall 13b of the motor housing member 13 becomes larger than the outer diameter of the stator core 23. Subsequently, the stator core 23 is inserted into the motor housing member 13 to reach a predetermined shrink-fitting position. Then, as the temperature of the motor housing member 13 becomes closer to normal temperature, the motor housing member 13 shrinks. This brings the inner circumferential surface of the peripheral wall 13b of the motor housing member 13 into close contact with the outer circumferential surface of the stator core 23.

Thus, when the stator core 23 is shrink-fitted to the motor housing member 13, the stator core 23 is positioned by, for example, inserting a jig 75 into the stator core 23. The motor housing member 13 is arranged in relation to the stator core 23 such that the stator core 23, of which the position relative to the jig 75 is determined, is inserted into the inner circumferential surface of the peripheral wall 13b of the motor housing member 13 to the predetermined shrink-fitting position. In this manner, the stator 22 is coupled to the housing 11.

As shown in FIG. 12, when inserting the jig 75, which is used for shrink-fitting the stator core 23 to the motor housing member 13, into the stator core 23, the jig 75 is inserted into the stator core 23 while being guided by the tapered wall 70. Therefore, when the jig 75 is inserted into the stator core 23, interference between the jig 75 and the cover member 65 is avoided, preventing difficulty in inserting the jig 75 into the interior of the stator core 23.

When the jig 75 is inserted into the stator core 23, the cover end wall 66 and the cover inner wall 68 prevent the jig 75 from contacting the first coil ends 32. Also, the cover end wall 66 and the cover inner wall 68 prevent the jig 75 from contacting parts of the phase-to-phase insulation sheets 46 that protrude beyond the insulator inner wall 54 on the side opposite to the first core end face 23a.

### Advantages of Embodiment

The above-described embodiment has the following advantages.

(1) The cover end wall 66 includes the tapered wall 70, which is inclined such that the distance between the tapered wall 70 and the insulator inner wall 54 decreases as the tapered wall 70 extends toward the cover inner wall 68. The tapered wall 70 is continuous with the cover inner wall 68. As such, when inserting the jig 75, which is used for shrink-fitting the stator core 23 to the motor housing member 13, into the stator core 23, the jig 75 is inserted into the stator core 23 while being guided by the tapered wall 70. Therefore, when the jig 75 is inserted into the stator core 23, interference between the jig 75 and the cover member 65 is avoided, preventing difficulty in inserting the jig 75 into the interior of the stator core 23. This improves the assembling efficiency of the stator 22 to the housing 11.

When the jig 75 is inserted into the stator core 23, the cover end wall 66 and the cover inner wall 68 prevent the jig 75 from contacting the first coil ends 32. Also, the cover end wall 66 and the cover inner wall 68 prevent the jig 75 from contacting parts of the phase-to-phase insulation sheets 46 that protrude beyond the insulator inner wall 54 on the side opposite to the first core end face 23a. As a result, the coils 28 are prevented from being damaged, and the phase-to-phase insulation sheets 46 are prevented from being deformed. Accordingly, the insulation between adjacent ones of the first coil ends 32 in the circumferential direction of the rotary shaft 15 is not hindered. This improves the reliability of the motor 20. Accordingly, the assembly of the stator 22 to the housing 11 is facilitated while improving the reliability of the motor 20.

(2) The phase-to-phase insulation sheets 46 are configured such that the edge 46e in the axial direction of the rotary shaft 15 of each phase-to-phase insulation sheet 46 includes the first edge 461, which protrudes beyond the first coil end 32 on the side opposite to the first core end face 23a. This readily ensures insulation between the first coil ends 32 that are adjacent to each other in the circumferential direction of the rotary shaft 15. Each phase-to-phase insulation sheet 46 is configured such that the edge 46e in the axial direction of the rotary shaft 15 of the phase-to-phase insulation sheet 46 includes the second edges 462, which do not protrude beyond the inner wall end 54e of the insulator inner wall 54 located on the side opposite to the first core end face 23a. The second edges 462 are formed by cutting out parts of the first edges 461 that extend from the ends μl located on the inner side in the radial direction of the rotary shaft 15 to the edge 46e of the phase-to-phase insulation sheet 46, which is located on the inner side in the radial direction of the rotary shaft 15. Thus, for example, as compared to a case in which the entire edge 46e of each phase-to-phase insulation sheet 46 protrudes beyond the first coil ends 32 and the insulator inner walls 54 on the side opposite to the first core end face 23a, the jig 75 is readily prevented from contacting the phase-to-phase insulation sheets 46.

(3) The cover end wall 66 is provided with the restricting portion 71, which contacts the edge 46e of each phase-to-phase insulation sheet 46 in the axial direction of the rotary shaft 15, thereby restricting movement of the phase-to-phase insulation sheet 46 in the axial direction of the rotary shaft 15. With this configuration, when the edge 46e of the phase-to-phase insulation sheet 46 in the axial direction of the rotary shaft 15 contacts the restricting portion 71, movement of the phase-to-phase insulation sheet 46 in the axial direction of the rotary shaft 15 is restricted. Since the position of each phase-to-phase insulation sheet 46 is determined, insulation between the coils 28 that are adjacent to each other in the circumferential direction of the rotary shaft 15 is stably achieved by the phase-to-phase insulation sheet 46.

(4) The tapered wall 70 is inclined from a part of the cover end wall 66 that overlaps with the radially outer portion 32b of each first coil end 32 in the axial direction of the rotary shaft 15. This configuration maximizes the inclination length of the tapered wall 70 as compared to a case in which the tapered wall 70 is inclined, for example, from a part of the cover end wall 66 that overlaps with the radially inner portion 32a of the first coil end 32 in the axial direction of the rotary shaft 15. Therefore, when inserting the jig 75, which is used for shrink-fitting the stator core 23 to the motor housing member 13, into the stator core 23, the jig 75 is readily guided into the stator core 23 by the tapered wall 70.

(5) The balancer 74 extends along the tapered wall 70 while protruding outward in the radial direction of the rotary shaft 15 from the part of the outer circumferential surface of the rotary shaft 15 that is located on the inner side of the cover inner wall 68. With this configuration, even if the balancer 74 protrudes outward in the radial direction of the rotary shaft 15 from the portion on the outer circumferential surface of the rotary shaft 15 located on the inner side of the cover inner wall 68, the balancer 74 does not interfere with the cover member 65 since the balancer 74 extends along the tapered wall 70. This allows the balancer 74 to protrude outward in the radial direction of the rotary shaft 15 from the part of the outer circumferential surface of the rotary shaft 15 that is located on the inner side of the cover inner wall 68. Since the balancer 74 is arranged as close to the stator core 23 as possible, the size of the motor-driven compressor 10 in the axial direction of the rotary shaft 15 is reduced.

### Modifications

The above-described embodiment may be modified as follows. The above-described embodiment and the following modifications can be combined as long as the combined modifications remain technically consistent with each other.

In the above-described embodiment, for example, the entire edge 46e of each phase-to-phase insulation sheet 46 may protrude beyond the first coil ends 32 and the insulator inner wall 54 on the side opposite to the first core end face 23a.

In the above-described embodiment, the cover member 65 may be configured such that the cover end wall 66 is not provided with the restricting portion 71.

In the above-described embodiment, the tapered wall 70 may be inclined, for example, from a part of the cover end wall 66 that overlaps with the radially inner portion 32a of the first coil end 32 in the axial direction of the rotary shaft 15.

In the above-described embodiment, the tapered wall 70 may be inclined, for example, from a part of the cover end wall 66 that overlaps with the first radially outer portion 321b of the first coil end 32 in the axial direction of the rotary shaft 15.

In the above-described embodiment, the cover inner wall 68 does not necessarily need to overlap with the insulator inner wall 54 in the axial direction of the rotary shaft 15.

In the above-described embodiment, the balancer 74 may protrude outward in the radial direction of the rotary shaft 15 from a part of the outer circumferential surface of the rotary shaft 15 that is farther from the stator core 23 than a part of the outer circumferential surface of the rotary shaft 15 located inward of the cover inner wall 68. The balancer 74 does not necessarily need to extend along the tapered wall 70.

In the above-described embodiment, the motor-driven compressor 10 may be configured without the balancer 74 on the rotary shaft 15. In this case, a balancer is arranged, for example, on the bushing of the scroll-type compression unit 16 having a conventional structure.

In the above-described embodiment, the cover member 65 may be disposed to face the second insulator 60. In this case, the stator core 23 is disposed in the motor housing member 13 such that the first core end face 23a faces the end wall 13a of the motor housing member 13 in the axial direction of the rotary shaft 15 and that the second core end face 23b faces the shaft supporting member 18 in the axial direction of the rotary shaft 15. For example, the inverter 17 is disposed on the outer side of the peripheral wall 13b of the motor housing member 13 in the radial direction of the rotary shaft 15, and the cluster block 44 is disposed, for example, between the second insulator 60 and the shaft supporting member 18.

In the above-described embodiment, the compression unit 16 is not limited to a scroll type, but may be, for example, a piston type or a vane type.

In the above-described embodiment, the motor-driven compressor 10 is used in the vehicle air conditioner. However, the present disclosure is not limited to this. For example, the motor-driven compressor 10 may be mounted on a fuel cell electric vehicle and use the compression unit 16 to compress air that is a fluid supplied to the fuel cell.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A motor-driven compressor, comprising:
a rotary shaft;
a compression unit configured to compress a fluid by rotation of the rotary shaft;
a motor configured to rotate the rotary shaft; and
a housing that includes a motor chamber accommodating the motor, wherein the motor includes a stator,
the stator includes:
a stator core fixed in the housing;
coils of multiple phases that are formed by windings of multiple phases wound on the stator core in a concentrated manner, the coils having coil ends protruding from a core end face of the stator core in an axial direction of the rotary shaft;
an insulator disposed to face the core end face, the insulator insulating the coils and the core end face from each other;
phase-to-phase insulation sheets each of which extends in a radial direction of the rotary shaft and insulates the coils that are adjacent to each other in a circumferential direction of the rotary shaft from each other; and
a cover member that has an insulating property and is disposed to face the insulator,
the insulator includes an insulator inner wall that is disposed at a position overlapping with the coil ends on an inner side of the coil ends in the radial direction of the rotary shaft,
each phase-to-phase insulation sheet insulates the coil ends that are adjacent to each other in the circumferential direction in a state in which the phase-to-phase insulation sheet protrudes beyond the core end face and partially protrudes beyond the insulator inner wall on a side opposite to the core end face,
the cover member includes:
an annular cover end wall that covers the coil ends on a side opposite to the core end face in the axial direction, and covers a part of each phase-to-phase insulation sheet that protrudes beyond the insulator inner wall on the side opposite to the core end face; and
a tubular cover inner wall that extends toward the insulator inner wall from a radially inner portion of the cover end wall,
the cover end wall includes a conical tapered wall that is inclined such that the distance between the cover end wall and the insulator inner wall decreases as the cover end wall extends toward the cover inner wall, and
the tapered wall is continuous with the cover inner wall.

2. The motor-driven compressor according to claim 1, wherein an edge in the axial direction of each phase-to-phase insulation sheet includes:
a first edge that protrudes beyond the coil ends on the side opposite to the core end face, and
a second edge that extends from an end of the first edge that is located on the inner side in the radial direction of the rotary shaft to an edge of the phase-to-phase insulation sheet that is located on the inner side in the radial direction, the second edge not protruding beyond an inner wall end of the insulator inner wall that is on the side opposite to the core end face.

3. The motor-driven compressor according to claim 1, wherein the cover end wall is provided with a restricting portion, and the restricting portion is configured to contact an edge in the axial direction of each phase-to-phase insulation sheet to restrict movement of the phase-to-phase insulation sheet in the axial direction.

4. The motor-driven compressor according to claim 1, wherein
each of the coil ends includes:
a radially inner portion that is a part located at a radially innermost position when the coil end is divided into three equal parts along a length in the radial direction; and
a radially outer portion that is a part of the coil end that is located on an outer side of the radially inner portion in the radial direction of the rotary shaft, and
the tapered wall is inclined from a part of the cover end wall that overlaps with the radially outer portion in the axial direction.

5. The motor-driven compressor according to claim 1, wherein
the compression unit includes:
a fixed scroll that is fixed to the housing; and
an orbiting scroll configured to orbit as the rotary shaft rotates while meshing with the fixed scroll,
the rotary shaft is provided with a balancer configured to cancel a centrifugal force acting on the orbiting scroll due to rotation of the rotary shaft, and
the balancer extends along the tapered wall while protruding outward in the radial direction of the rotary shaft from a part of an outer circumferential surface of the rotary shaft that is located on an inner side of the cover inner wall.
